(19) United States
(12) Patent Application Publication
(10) Pub. No.: US 2010/0187473 A1
(43) Pub. Date: Jul. 29, 2010

(54) Oxide-Like Hydrotalcite and Manufacturing Process Thereof

(75) Inventors: DongHo Hyun, Cheongju-si (KR); Sung Wook Lee, Daejeon (KR); Young-Guk Kim, Cheongju-si (KR)

Correspondence Address: SUGHRUE MION, PLLC, 2100 PENNSYLVANIA AVENUE, N.W., SUITE 800, WASHINGTON, DC, 20037, US

(73) Assignee: DOOBON INC., Chungcheogbuk-do (KR)

(21) Appl. No.: 12/305,706

(22) PCT Filed: Dec. 7, 2007
(86) PCT No.: PCT/KR2007/006349

§ 371 Date: Dec. 19, 2008

(30) Foreign Application Priority Data
Dec. 7, 2006 (KR) 10-2006-0124016

(51) Int. Cl. C09K 3/00

(52) U.S. Cl. 252/182.33; 252/182.35

(57) ABSTRACT

An oxide-like hydrotalcite having a certain structure and uniform size can be prepared by a method comprising milling and heat or microwave post-treatment, and it is capable of providing synthetic resins with high heat- and chlorine-resistance.

### FIELD OF THE INVENTION

The present invention relates to an oxide-like hydrotalcite having a uniform size which is capable of providing synthetic resins with high heat- and chlorine-resistance when added thereto, and a manufacturing process thereof.

### BACKGROUND OF THE INVENTION

Hydrotalcites represented by a general formula of [M^{II}₁₋ₓM^{III}ₓ(OH)₂(Aⁿ⁻)_{2/n}·mH₂O], a class of metal hydroxides, have a double layered structure, the interlayer of which hosts water molecules (referred to as “crystal water”) as well as anions that balance the overall charge, wherein M^{II} is a divalent metal, M^{III} is a trivalent metal, and Aⁿ⁻ is an anion having an atomic valence of n.

Such hydrotalcites are prepared by the conventional “coprecipitation technique” or “high-pressure hydrothermal process” using metal salts, metal oxides, metal hydroxides or urea (see U.S. Pat. Nos. 4,351,814, 4,904,457 and 5,250,279, Japanese Patent Laid-open Publication Nos. 1994-329410 and 1975-30039, and Korean Patent No. 454273). The coprecipitation technique comprises dissolving the starting material in a solvent, and subjecting the solution to coprecipitation and aging to induce the growth of hydrotalcite particles, and the high-pressure hydrothermal process comprises subjecting a slurry containing a starting material to a hydrothermal reaction in a high-pressure chamber to synthesize the hydrotalcite particles.

A hydrotalcite prepared by the conventional method usually contains water molecules adsorbed on the surface thereof in addition to the crystal water molecules. It is well known that when heat-treated at various temperatures, such a hydrotalcite undergoes distinct changes: the loss of the water molecules adsorbed on the surface occurs at a certain temperature range; the loss of the crystal water occurs at a higher temperature; and at an even higher temperature, dehydroxylation and decomposition take place.

Hydrotalcites are widely used as an additive for the enhancement of heat- and chlorine-resistance of various synthetic resins such as polyvinyl chlorides (PVC) and polyurethanes. However, the conventional hydrotalcites used for said purpose have the problem that they do not provide the resin with satisfactory heat- and chlorine-resistance. Such a problem arises primarily due to their ununiform sizes, the deterioration of their to properties at high synthetic resin processing temperatures and adverse effects brought about by the release of the crystal water during the processing.

### SUMMARY OF THE INVENTION

Accordingly, it is an object of the present invention to provide a hydrotalcite having a small and uniform size which is capable of providing synthetic resins with high heat- and chlorine-resistance, and a process for manufacturing said hydrotalcite.

In accordance with one aspect of the present invention, there is provided an oxide-like hydrotalcite having an average secondary particle diameter of 3 μm or less which is represented by formula (I):

(M^{II}₁₋ₐ^{oct}M^{II}ₐ^{tet})₄₊ₓ(M^{III}_{1-b}^{oct}M^{III}_{b}^{tet})₂(OH)_{12+2x-2y}O_{y}(Aⁿ⁻)_{2/n}·mH₂O (I)

wherein,

M^{II} is a divalent metal selected from the group consisting of Mg, Ca, Co, Zn and Ni;

M^{III} is a trivalent metal selected from the group consisting of Al, Fe, Co, Mn and Ti;

M^{II oct} and M^{IIIoct} represent M^{III} and M^{II} which are each positioned in the central site of an octahedron structure having six ligands;

M^{I tet} and M^{III tet} represent M^{II} and M^{III} which are each positioned in the central site of a tetrahedron structure having four ligands;

Aⁿ⁻ is an anion having an atomic valence of n which is selected from the group consisting of CO₃²⁻, HPO₄²⁻, NO³⁻, SO₄²⁻, OH⁻, F⁻, Cl⁻ and Br⁻; which satisfies the conditions of 0≦x≦4, 0<a≦0.5, 0<b≦0.5, 0<y≦6 and m≧0.

In accordance with another aspect of the present invention, there is provided a process for manufacturing the oxide-like hydrotalcite of formula (I) which comprises dissolving a starting material in a solvent and then subjecting the solution to coprecipitation and aging, or subjecting a slurry of a starting material to a hydrothermal reaction in a high-pressure chamber, to synthesize hydrotalcite particles,

wherein the product of the coprecipitation is subjected to ball-milling, or one or both of the starting slurry and the product of the hydrothermal reaction is subjected to ball-milling; and the synthesized hydrotalcite particles are subjected to heat or microwave treatment, or both.

### BRIEF DESCRIPTION OF THE DRAWINGS

The above and other objects and features of the present invention will become apparent from the following description of the invention, when taken in conjunction with the accompanying drawings, which respectively show:

FIGS. 1A to 1C: SEM photographs of the respective hydrotalcites synthesized under different treatment conditions;

FIG. 2: ²⁷Al MAS-NMR spectra of the hydrotalcite heat-treated at 240° C. for 2 hrs, and the reconstructed hydrotalcite exposed to the air after such heat treatment;

FIG. 3: FTIR spectra of the hydrotalcite before and after heat-treatment at 240° C. for 2 hrs;

FIG. 4: powder XRD patterns of the hydrotalcite before and after heat-treatment at 240° C. for 2 hrs, and the reconstructed hydrotalcite; and

FIG. 5: secondary particle size distribution curves obtained for the hydrotalcites obtained in Comparative Example 1 and Examples 1 to 4.

### DETAILED DESCRIPTION OF THE INVENTION

The preparation of a hydrotalcite in accordance with the present invention is characterized by milling to achieve nano-dispersing of particles having a uniform particle size distribution, as well as by stabilizing its particle distribution by heat or microwave post-treatment, to generate stabilized hydrotalcite particles which are partially or completely dehydrated. The inventive oxide-like hydrotalcite thus obtained is comprised of small and uniform particles, which are effective in enhancing the properties of the to synthetic resin.

The inventive oxide-like hydrotalcite of formula (I) is prepared by (i) milling using bead mill balls before and/or after the coprecipitation or hydrothermal reaction of the starting material, and then (ii) heat-treating and/or microwave-treating the hydrotalcite particles synthesized through the coprecipitation or hydrothermal reaction.

In step (i), the bead mill ball-milling may be conducted at a rate of about 100 to about 3,500 rpm for about 0.5 to about 2 hrs. The bead mill balls suitable for use in step (i) may be made of alumina, zirconia, or zirconium silicate, having a diameter ranging from about 0.1 to about 2.0 mm. In case of the coprecipitation, such milling inhibits the coagulation of coprecipitated particles, to allow uniform growth thereof. The above coprecipitation and aging may be conducted according to any one of the conventional methods. Preferably, the aging may be performed at a temperature ranging from about 60 to about 90° C. In case of the hydrothermal reaction, the milling before and/or after the synthesis of particles can give rise to a nano-dispersing effect to obtain desired uniform particles. The above hydrothermal reaction may be conducted under a high pressure according to any one of the conventional methods. It is suitable that the hydrothermal reaction may be performed at a temperature ranging from about 150 to about 200° C., preferably from about 160 to about 170° C. for about 1 to about 6 hrs, preferably about 2 to about 4 hrs.

The inventive hydrotalcite obtained via the milling process has an average secondary particle diameter of about 3 μm or less, preferably from about 0.1 to about 3 μm. Further, the inventive hydrotalcite particles exhibit a very narrow particle size distribution: For example, 90% of the hydrotalcite particles (D_{0.9}) has a secondary particle diameter of not more s than 6.0 μm. In fact, when the average secondary particle diameter exceeds 3 μm, an undesirable pressure increase occurs in the spinner, which makes it difficult to uniformly disperse the hydrotalcite particles in a resin, leading to the lowering of the heat- and chlorine-resistance of the final resin product.

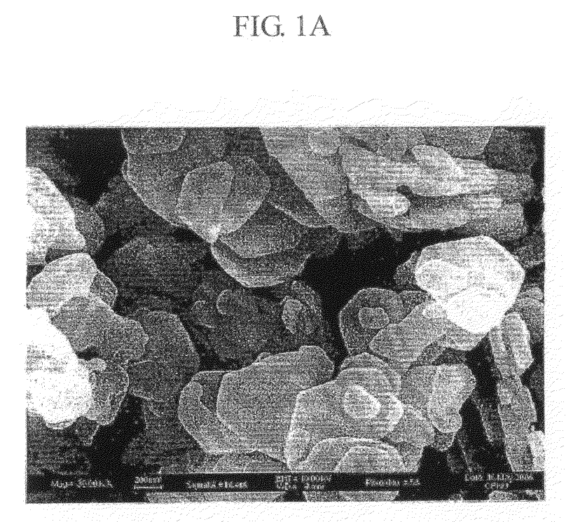

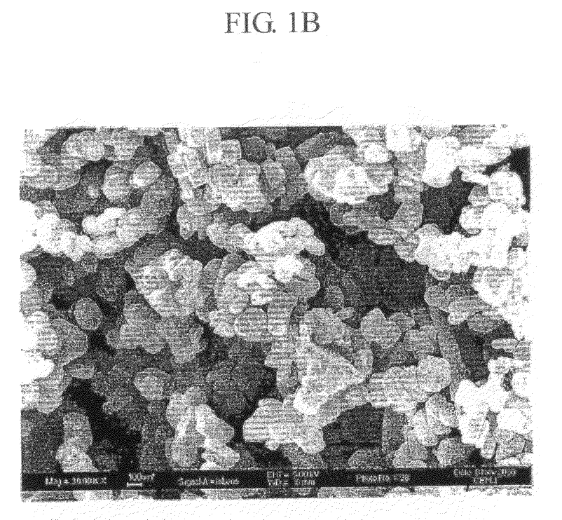

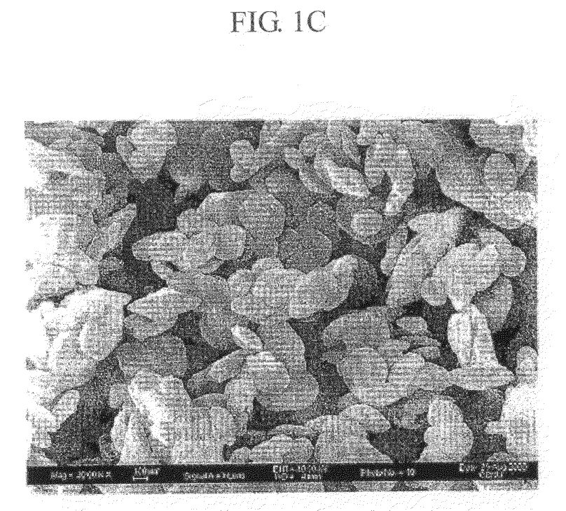

SEM photographs of the respective hydrotalcites synthesized under different treatment conditions are shown in FIGS. 1A to 1C (FIG. 1A: conventional coprecipitation or hydrothermal reaction, FIG. 1B: \textcircled{1} bead mill ball-milling+\textcircled{2} conventional coprecipitation or hydrothermal reaction, FIG. 1C: \textcircled{1} bead mill ball-milling+\textcircled{2} conventional coprecipitation or hydrothermal reaction+\textcircled{3} heat treatment). The photographs of FIGS. 1A to 1C reveal that the hydrotalcite particles not milled (FIG. 1A) are ununiform and have an average particle diameter of about 5 μm or more, whereas the milled hydrotalcite particles (FIGS. 1B and 1C) are uniform and have an average particle diameter of not more than about 3 μm.

In step (ii), the heat treatment may be conducted at a temperature ranging from about 220 to about 300° C., preferably from about 230 to about 250° C. for about 1 to about 4 hrs, preferably about 2 to about 3 hrs; and the microwave treatment, with an output power ranging from about 300 W to about 60 kW for about 5 min to about 1 hr, preferably about 20 to about 30 min. In case of conducting both the heat and microwave treatments, the heat treatment is preferably performed at a temperature ranging from about 50 to about 300° C. for about 1 to about 4 hrs, and the microwave treatment, with an output power ranging from about 300 W to about 60 kW for about 5 min to about 1 hr.

The above-mentioned heat and/or microwave treatment removes, partially or completely, the crystal water molecules (dehydration) and also some hydroxyl groups (dehydroxylation) to give the inventive oxide-like hydrotalcite of formula (I).

In the hydrotalcite of formula (I), preferably, M^{II} is Mg; M^{III} is Al; Aⁿ⁻ is CO₃²⁻; and 0.001≦a≦0.3 and 0.01≦b≦0.5 with the proviso of a<b.

The term ‘oxide-like hydrotalcite’ used in the present invention refers to a hydrotalcite that have undergone partial or complete dehydration of the crystal water molecules disposed between double layers, and partial dehydroxylation of the hydroxyl groups coordinated to a metal. Both the hydroxyl groups coordinated to the divalent and trivalent metals may undergo dehydroxylation, but those attached to the trivalent metals are more susceptible to dehydroxylation.

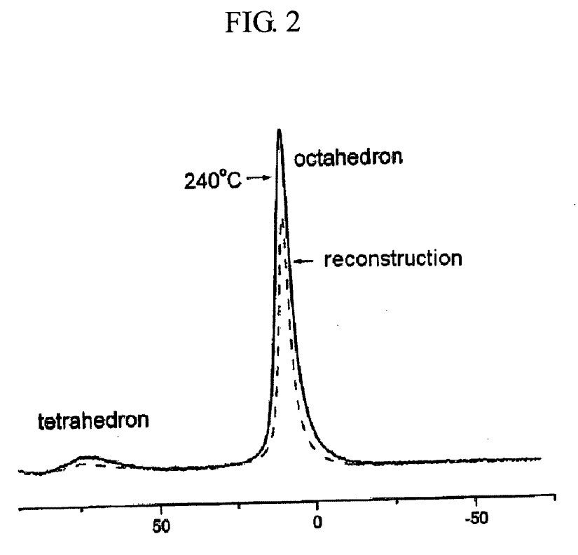

The dehydroxylation occurs according to the reaction, 2OH⁻→H₂O+O²⁻, which changes in part the coordination numbers of the divalent and trivalent metal cations, specifically, from original six-coordination (the octahedron structure) to five and four-coordination (the tetrahedron structure). The presence of four- and six-coordinated structures is confirmed in FIG. 2. Although the dehydroxylation may proceed up to the extent of 50% of the total hydroxyl groups, the empty space created by removed hydroxyl groups is filled with the oxygen species generated by the dehydroxylation and interlayer anions (e.g., CO₃²⁻). Consequently, the number of the octahedron structure of six-coordination dominates over that of the tetrahedron structure of four-coordination. For example, the six-coordination:four-coordination ratio of the hydrotalcite partially dehydroxylated by the heat-treatment at 240° C. for 2 hrs is about 88.8:11.2. The probable coordination structure of the metal after the dehydroxylation is: M(OH)₆, M(OH)₅O, M(OH)₄O₂, M(OH)₄, M(OH)₅ . . . OCO₂ and KOH)₄ . . . O₂CO (M: divalent or trivalent metal cations). Meanwhile, the removal of the crystal water molecules, i.e., the dehydration, makes the interlayer space of the hydrotalcite narrow.

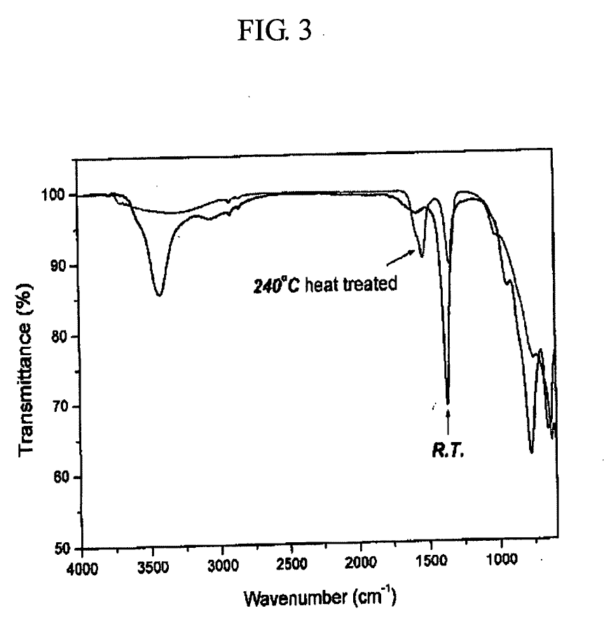

An ²⁷Al MAS-NMR spectrum of the hydrotalcite heat-treated at 240° C. for 2 hrs, and FTIR spectra of the hydrotalcites before and after heat-treated at the same condition are shown in FIGS. 2 and 3, respectively. FIG. 2 demonstrates that octahedron and tetrahedron structures are both present. As FIG. 3 shows peaks at 1300-1400 and 1500-1600 cm⁻³ wavenumber regions, the loss of anions in the interlayer by dehydroxylation causes a significant change in the structure. Such change in the binding of the interlayered anions leads to an overall unbalance in electric charges, and thus, a dehydroxylated hydrotalcite tends to absorb anions from its surrounding.

When the oxide-like hydrotalcite of formula (I) is exposed to the open air, it immediately absorbs moisture to convert to a reabsorbed or reconstructed hydrotalcite. The reabsorbed or reconstructed hydrotalcite maintains the metal layer structure altered by the heat-treatment, the absorbed water filling the interlayer as crystal water. As the refilled crystal o water forms weak hydrogen bonds due to the change in the symmetry of interlayer anions and the lowering of electric density, it can be removed from the reconstructed hydrotalcite at a temperature lower than before the reconstruction. An ²⁷Al MAS-NMR spectrum of the reconstructed hydrotalcite (heat-treated at 240° C. for 2 hrs and exposed to the air) is shown in FIG. 2, which suggests that both octahedron and tetrahedron structures are still present.

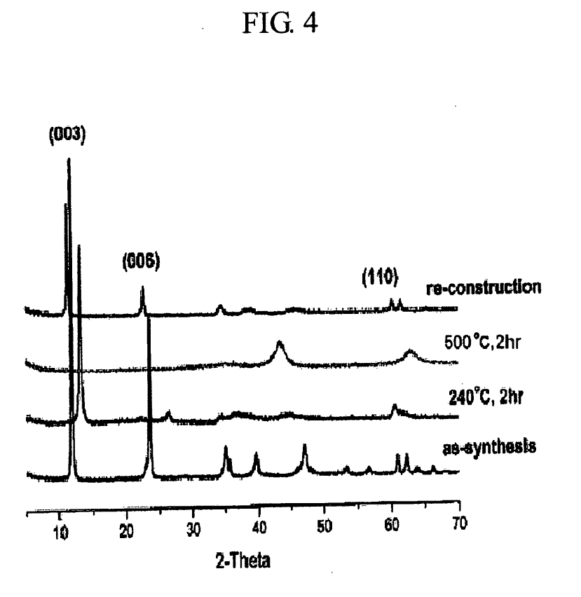

In addition, powder XRD scans of the hydrotalcites before and after heat-treated at 240° C. for 2 hrs, and the reconstructed hydrotalcite are shown in FIG. 4, which demonstrates that the interlayer space of the reconstructed hydrotalcite is restored to the original untreated state.

The inventive hydrotalcite may be added to a synthetic resin as is or in a further processed form. Preferably, the hydrotalcite may be further coated with at least one surface-treating agent. Exemplary surface-treating agents used in the present invention include high molecular weight fatty acids such as stearic acid and nonanoic acid; silane-based coupling agents (formula: Y—Si(OR)₃, wherein Y is alkyl, vinyl, aryl, amino, methacryl or mercapto; R is methyl, ethyl, acetyl, propyl, isopropyl, isopropylphenoxy or phenoxy); titanate-based coupling agents such as isopropyltriisostearoyl titanate, isopropyltris(dioctylpirophosphate)titanate, isopropyltri(N-aminoethyl-aminoethyl)titanate and isopropyltridecylbenzene sulfonyl titanate; phosphoric ester such as mono- or di-ester of orthophosphoric acid and stearylalcohol; and aluminum-based coupling agents such as acetalkoxy aluminum diisopropylate.

The coating of the hydrotalcite particles with the above-mentioned surface-treating agent may be carried out in accordance with any one of the conventional wet or dry coating methods. For instance, the wet coating may be conducted by adding the surface-treating agent to a slurry containing hydrotalcite particles, and then thoroughly stirring the resulting mixture at about 100° C.; and drying the coating. The amount of the surface-treating agent may be about 10 parts by weight or less, preferably in a range of about 0.1 to about 5 parts by weight based on 100 parts by weight of the hydrotalcite particles.

As described above, the inventive hydrotalcite has a small and uniform size, and it is capable of providing synthetic resins with high heat- and chlorine-resistance when added thereto, and, therefore, it is a very useful additive in manufacturing synthetic resins.

The following Examples and Comparative Examples are given for the purpose of illustration only, and are not intended to limit the scope of the invention.

### Comparative Example 1

0.67 mole of magnesium chloride was dissolved in 0.5 L of water and 0.33 mole of sodium aluminate was added thereto to form a slurry. 1.34 mole of sodium hydroxide and 0.33 mole of sodium bicarbonate were further added to the slurry and stirred for 30 min. The resulting slurry was subject to a hydrothermal reaction under a high pressure of 100 psi with stirring at 400 rpm for 2 hrs, and then kept at an ambient pressure. The resulting mixture was filtered, and the isolated precipitate was washed with water, dispersed in 3% stearic acid and stirred at 100° C. for 30 min to complete the surface-treatment of the precipitate. The surface-treated product was isolated by filtering to obtain a hydrotalcite powder of formula [(Mg₄Al₂)(PH)₁₂CO₃.3H₂O].

### Comparative Example 2

The procedure of Comparative Example 1 was repeated except that the hydrotalcite powder was heat treated at 240° C. for 1 hr, to obtain a hydrotalcite powder of formula [(Mg₁₋ₐ^{oct}Mgₐ^{tet})₄(Al_{0.89}^{oct}Al_{0.11}^{tet})₂(OH)₈O₂(CO₃)] (0<a<0.11).

### Example 1

The procedure of Comparative Example 2 was repeated except that the slurry was milled at a rate of 3,000 rpm for 90 min using zirconia bead mill balls (diameter: 0.65 mm) prior to the hydrothermal reaction, to obtain a hydrotalcite powder of formula [(Mg₁₋ₐ^{oct}Mgₐ^{tet})₄(Al_{0.89}^{oct}Al_{0.11}^{tet})₂(OH)₈O₂(CO₃)] (0<a<0.11).

### Example 2

The procedure of Example 1 was repeated except that the filtered precipitate obtained after water-washing was milled, to obtain a hydrotalcite powder of formula [(Mg₁₋ₐ^{oct}Mgₐ^{tet})₄(Al_{0.89}^{oct}Al_{0.11}^{tet})₂(OH)₈O₂(CO₃)] (0<a<0.11).

### Example 3

The procedure of Comparative Example 1 was repeated except that the filtered precipitate obtained after water-washing was milled at a rate of 3,000 rpm for 90 min using zirconia bead mill balls (diameter: 0.65 mm), and final product obtained therein was subjected to a microwave treatment with an output power of 6 kW for 20 min using a microwave oven (Jugnhwa Industry Co., Ltd.), to obtain a hydrotalcite powder having a composition of [(Mg₁₋ₐ^{oct}Mgₐ^{tet})₄(Al_{0.89}^{oct}Al_{0.11}^{tet})₂(OH)₈O₂(CO₃)] (0<a<0.11).

### Example 4

The procedure of Example 2 was repeated except that the microwave treatment was performed with an output power of 6 kW for 20 min using a microwave oven after the heat treatment, to obtain a hydrotalcite powder having a composition of [(Mg₁₋ₐ^{oct}Mgₐ^{tet})₄(Al_{0.89}^{oct}Al_{0.11}^{tet})₂(OH)₈O₂(CO₃)] (0<a<0.11).

### Test Example 1

### Measurement of Secondary Particle Diameter and Heat Stability

In order to determine the heat stabilities of the hydrotalcites obtained in Comparative Examples 1 and 2, and Examples 1 to 4, the following test was conducted: 100 parts by weight of a polyvinyl chloride (PVC) resin, 40.0 parts by weight of dioctyl phthalate (DOP), 0.2 parts by weight of a Zn-based stabilizer, 0.05 parts by weight of dibromomethane (DBM) and 2.0 parts by weight of one of the hydrotalcites were blended at 160° C. at a rate of about 30 rpm for 5 min, the blend was passed through a set of rolls to prepare a resin sheet of about 0.5 mm-thickness. The resin sheet was cut into several pieces, placed in an oven heated to 195° C., and took out at predetermined intervals. The change in the color of the resin sheet was observed with the naked eye, and the heat stability of the resin sheet was determined based on the time required to turn the color of the sample into a specified black hue. The results are shown in Table 1.

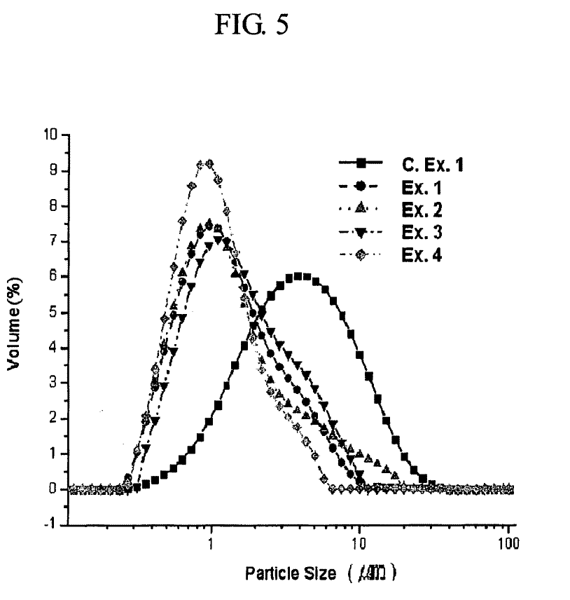

Further, the secondary particle diameters of the hydrotalcites obtained in Comparative Example 1, and Examples 1 to 4 are shown in Table 2 and FIG. 5, wherein D_{Z} means the value on the x-axis, the integrated area between 0 and x of the secondary particle size distribution curve obtained for the hydrotalcite corresponding to 100×z %.

TABLE 1

| Time (min) | Comp. Ex. 1* | Comp. Ex. 2 | Ex. 1 | Ex. 2 | Ex. 3 | Ex. 4 |
|---|---|---|---|---|---|---|
| 0 | ◯ | ⊚ | ⊚ | ⊚ | ⊚ | ⊚ |
| 15 | ◯ | ⊚ | ⊚ | ⊚ | ⊚ | ⊚ |
| 30 | Δ | ◯ | ◯ | ◯ | ◯ | ◯ |
| 45 | Δ | Δ | ◯ | ◯ | ◯ | ◯ |
| 60 | X | Δ | Δ | Δ | Δ | ◯ |
| 75 | XX | X | Δ | Δ | Δ | ◯ |
| 90 | XX | X | X | X | X | Δ |

Note:
⊚: very good,
◯: good,
Δ: middle,
X: poor,
XX: very poor
*weak initial coloring

TABLE 2

| μm | Comp. Ex. 1 | Ex. 1 | Ex. 2 | Ex. 3 | Ex. 4 |
|---|---|---|---|---|---|
| D_{0.1} | 1.302 | 0.547 | 0.546 | 0.549 | 0.529 |
| Average | 4.091 | 1.269 | 1.245 | 1.312 | 1.059 |
| diameter (D_{0.5}) | | | | | |
| D_{0.9} | 12.011 | 4.090 | 5.359 | 4.306 | 2.690 |

As can be seen from Tables 1 and 2, the inventive oxide-like hydrotalcites of Examples 1 to 4 have a small and uniform size, and can impart high heat- and chlorine-resistance to a synthetic resin.

While the invention has been described with respect to the above specific embodiments, it should be recognized that various modifications and changes may be made to the invention by those skilled in the art which also fall within the scope of the invention as defined by the appended claims.

What is claimed is:

1. An oxide-like hydrotalcite having an average secondary particle diameter of 3 μm or less which is represented by formula (I):
(M^{II}₁₋ₐ^{oct}M^{II}ₐ^{tet})₄₊ₓ(M^{III}_{1-b}^{oct}M^{III}_{b}^{tet})₂(OH)_{12+2x-2y}O_{y}(Aⁿ⁻)_{2/n}·mH₂) (I)
wherein,
M^{II} is a divalent metal selected from the group consisting of Mg, Ca, Co, Zn and Ni;
M^{III} is a trivalent metal selected from the group consisting of Al, Fe, Co, Mn and Ti;
M^{II oct} and M^{III oct} represent M^{II} and M^{III} which are each positioned in the central site of an octahedron structure having six ligands;
M^{II tet} and M^{IIItet} represent M^{II} and M^{III} which are each positioned in the central site of a tetrahedron structure having four ligands;
is Aⁿ⁻ is an anion having an atomic valence of n which is selected from the group consisting of CO₃²⁻, HPO₄²⁻, NO³⁻, SO₄²⁻, OH⁻, F⁻, Cl⁻ and Br⁻; which satisfies the conditions of 0≦x≦4, 0<a≦0.5, 0<b≦0.5, 0<y≦6 and m≧0.

2. The oxide-like hydrotalcite of claim 1, wherein a is in the range of 0.001 to 0.3 and b is in the range of 0.01 to 0.5, with the proviso that a<b.

3. The oxide-like hydrotalcite of claim 1, wherein 90% of the hydrotalcite particles (D_{0.9}) has a secondary particle size of 6.0 μm or less.

4. A process for manufacturing the oxide-like hydrotalcite of claim 1 which comprises dissolving a starting material in a solvent and then subjecting the solution to coprecipitation and aging, or subjecting a slurry of a starting material to a hydrothermal reaction in a high-pressure chamber, to synthesize hydrotalcite particles,
wherein the product of the coprecipitation is subjected to ball-milling, or one or both of the starting slurry and the product of the hydrothermal reaction is subjected to ball-milling; and the synthesized hydrotalcite particles are subjected to heat or microwave treatment, or both.

5. The process of claim 4, wherein the milling is conducted at a rate ranging from 100 to 3,500 rpm for 0.5 to 2 hrs.

6. The process of claim 4, wherein the mill balls are made of alumina, zirconia or zirconium silicate, and have a diameter ranging from 0.1 to 2.0 mm.

7. The process of claim 4, wherein the heat treatment is conducted at a to temperature ranging from 220 to 300° C. for 1 to 4 hrs.

8. The process of claim 4, wherein the microwave treatment is conducted with an output power ranging from 300 W to 60 kW for 5 min to 1 hr.
